(19) United States
(12) Patent Application Publication
(10) Pub. No.: US 2026/0075619 A1
(43) Pub. Date: Mar. 12, 2026

(54) DOWNLINK CONTROL INFORMATION DECODING BASED ON ASSUMED FIELD VALUES

(71) Applicant: QUALCOMM Incorporated, San Diego, CA (US)

(72) Inventors: Yevgeny ZAGALSKY, Kfar Saba (IL); Konstantin KUPERSHLAK, Ramat Gan (IL); Ran BERLINER, Kfar Aviv (IL); Shay LANDIS, Hod Hasharon (IL); Amit BAR-OR TILLINGER, Tel-Aviv (IL); Eitan YERUSHALMI, Tel-Aviv (IL)

(21) Appl. No.: 18/828,163

(22) Filed: Sep. 9, 2024

(51) Int. Cl. H04W 72/232; H04W 72/044

(52) U.S. Cl. CPC H04W 72/232; H04W 72/044

(57) ABSTRACT

Certain aspects of the present disclosure provide techniques for allocating downlink channel resource(s) for a device supporting known downlink control information (DCI) values. A method generally includes receiving an indication of one or more DCI fields that indicates to assume a respective value for each of the one or more DCI fields to attempt to decode a downlink control channel candidate; and attempting to decode the downlink control channel candidate to obtain DCI based on the respective value for each of the one or more DCI fields.

### FIELD OF THE DISCLOSURE

Aspects of the present disclosure relate to wireless communications, and more particularly, to techniques for communicating downlink control information (DCI).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving an indication of one or more downlink control information (DCI) fields that indicates to assume a respective value for each of the one or more DCI fields to attempt to decode a downlink control channel candidate; and attempting to decode the downlink control channel candidate to obtain DCI based on the respective value for each of the one or more DCI fields.

Another aspect provides a method for wireless communications by an apparatus. The method includes sending, to a device, an indication of one or more DCI fields that indicates for the device to assume a respective value for each of the one or more DCI fields to attempt to decode a downlink control channel candidate; and sending, to the device, the downlink control channel candidate.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example scheme for configuring a set of time-frequency resources for communication of control signaling.

FIG. 6 depicts an example association between aggregation level and downlink channel coverage for different downlink control information (DCI) payload sizes.

FIG. 7 depicts an example wireless communications network.

FIG. 8 depicts an example process flow for communication of DCI based on assumed DCI field value(s).

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for decoding downlink control information (DCI) assuming one or more values (also referred to as DCI field value(s)) for one or more fields of the DCI.

A wireless communication system may include a number of devices (e.g., terminals, network entities, and other devices) exchanging data, control information, reference signals, etc. (e.g., communicating) with each other. In some examples, a wireless communication system may generally include or refer to a number of devices and network entities employing techniques for exchanging information wirelessly. For example, a wireless communication system may include terminals (e.g., user devices or user equipments (UEs)) and network entities (e.g., base stations (BS)) that (e.g., wirelessly) communicate data, control information, reference signals, etc. (e.g., according to various wireless communication system implementations). Devices and network entities operating in a wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, improve the quality of communication between devices and network entities, etc.

In some aspects, a device may attempt to obtain downlink data or information from a network entity by performing blind decodes on a set of time and frequency resources. For example, a physical downlink control channel (PDCCH) control resource set (CORESET) defines a set of time and frequency resources where PDCCH data (e.g., DCI message(s)) can be transmitted by a network entity. The network entity may initially send, to the device, a configuration (e.g., via radio resource control (RRC) signaling) indicating the set of time and frequency resources included in the PDCCH CORESET. Subsequently, the network entity may then send DCI messages somewhere within the PDCCH CORESET. However, the network entity may not share parameters about the DCI messages (e.g., a location, channel, and/or size of the DCI messages) with the device, such that the device performs the blind decodes to obtain DCI from the DCI messages. That is, the network device may not indicate a detailed structure of the PDCCH CORESET (e.g., number of PDCCHs in the CORESET, number of CCEs to which each PDCCH is mapped, etc.) to the device, and multiple PDCCHs can be transmitted in a single subframe, where each of the multiple PDCCHs may or may not be relevant to a particular device. Accordingly, as part of the blind decoding, the device may search for a PDCCH specific to the device by monitoring a set of PDCCH candidates (e.g., a set of consecutive CCEs in the CORESET on which a PDCCH could be mapped) in every subframe, and the device may use a Radio Network Temporary Identifier (RNTI) configured for the device to try and decode PDCCH candidates to obtain DCI from DCI messages in the PDCCH candidates. For example, the RNTI may be used to demask a cyclic redundancy check (CRC) of a PDCCH candidate, and if no CRC error is detected, the device may determine that a corresponding PDCCH candidate carries DCI for the device, such as in one or more DCI messages.

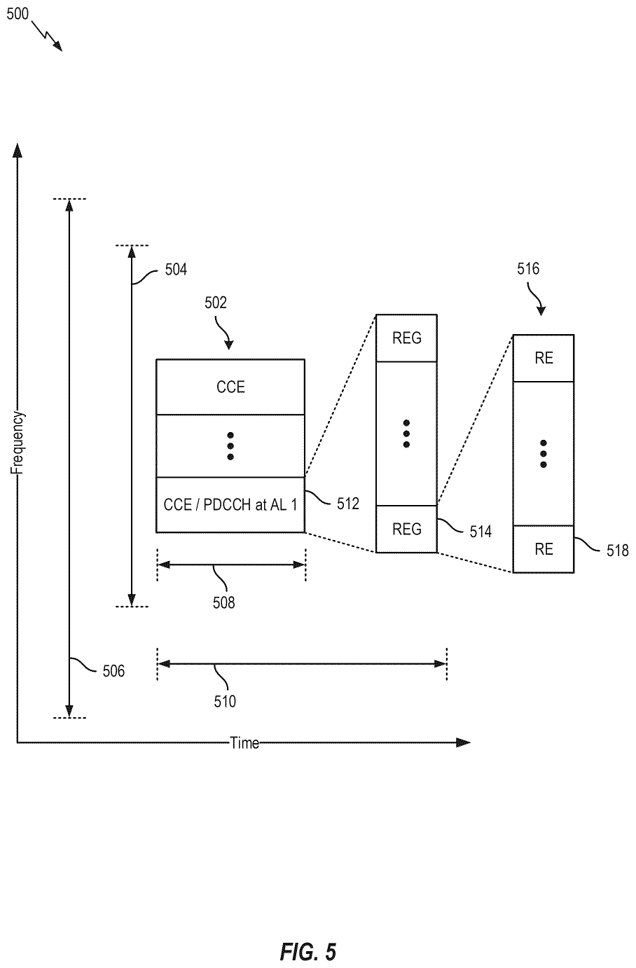

In certain aspects, time and frequency resources configured by a CORESET can be shared between multiple UEs camping on a same cell or beam and, in some cases, can also be used for physical downlink shared channel (PDSCH) data transmissions. Additionally, search spaces (SSs) associated with a CORESET define a list of candidates (e.g., location and size in terms of control channel elements (CCEs)) that a device (e.g., UE) can use to try to decode DCI messages. Subsequently, when a network entity transmits DCI to a device, the network entity uses one of the PDCCH SS candidates that meets current network requirements (e.g., using an aggregation level (AL) that is sufficient for sending the DCI according to its size over existing channel conditions). PDCCH transmissions are described in greater detail with reference to FIG. 5.

One or more technical problems arise for communicating DCI. For example, for transmission of a DCI of a given size, a higher AL may increase robustness and coverage of a PDCCH transmission but may consume a higher amount of time and frequency resources (e.g., a higher AL corresponds to a higher number of CCEs configured in SSs), thus reducing a total cell capacity. Additionally or alternatively, a lower AL may consume fewer time and frequency resources but may decrease robustness and coverage of the PDCCH transmission, which may reduce a reliability that the PDCCH transmission is successfully received and decoded by corresponding devices. Thus, technical problems arise for allocating downlink channel resources for DCI to achieve high PDCCH performance (e.g., high robustness and coverage) while also using fewer time and frequency resources (e.g., to increase total cell capacity).

In some aspects, reducing a payload size of the DCI messages carrying the DCI may increase a code ratio of the PDCCH transmission (e.g., ratio of information bits to the total number of bits transmitted in the PDCCH, including information and redundant bits), thereby achieving high PDCCH performance (e.g., high robustness and coverage) with lower ALs (e.g., fewer time and frequency resources). For example, the DCI messages may include multiple fields, where each field of the DCI message(s) may specify one or more configuration parameters of a corresponding scheduling grant and/or other parameters. For example, the scheduling grant may be sent as a DCI message (e.g., using DCI formats 0_0 or 0_1) that schedules communications via a subsequent channel after the PDCCH, such as a PDSCH, a physical uplink control channel (PUCCH), a physical uplink shared channel (PUSCH), etc.

Values of some of the fields of the DCI message(s) (e.g., DCI field values) may be expected to more likely differ for different scheduling grants. For example, the fields that may more likely differ may include a resource assignment, a hybrid automatic repeat request (HARQ) process identifier (ID), a new data indication, etc., for different scheduling grants. Additionally or alternatively, values of other fields of the DCI message(s) may not be frequently updated and/or may not be expected to likely differ for different scheduling grants. For example, the fields that are not frequently updated and/or not expected to likely differ may include a bandwidth part (BWP) index, a resource block (RB) mapping (e.g., virtual RB-to-physical RB (VRB2PRB) mapping), a transmit power control (TPC) command (e.g., for a scheduled PUCCH), sounding reference signal (SRS) request, a modulation and coding scheme (MCS), antenna ports, etc.

The techniques and signaling described herein provide a technical solution to the technical problem of how to communicate DCI using fewer time and frequency resources, while still achieving higher PDCCH performance. For example, certain aspects provide techniques for leveraging the DCI field values that are not frequently updated and/or not expected to likely differ for different scheduling grants. Certain aspects provide techniques for a network entity to indicate to a device one or more DCI field values for which the device can assume respective value(s) for decoding DCI. In certain aspects, the device may utilize the assumed respective value(s) to attempt to decode the DCI, thereby increasing the likelihood of successfully decoding the DCI when the assumed respective value(s) are correct. Accordingly, in certain aspects, fewer time and frequency resources may be used to communicate the DCI field values for which the device may assume respective value(s), and such DCI field values may be successfully decoded based on the assumption, thereby allowing the communication of DCI with fewer time and frequency resources, while still achieving higher PDCCH performance. For example, in certain aspects, if the network entity does not indicate the one or more DCI field values for which the device can assume respective value(s) for decoding DCI, the network entity may use a first AL for sending the DCI, where the first AL corresponds to a first number of CCEs that occupy a first number of time and frequency resources for the device to attempt to decode the DCI with high PDCCH performance. Alternatively, in certain aspects, if the network entity does indicate the one or more DCI field values for which the device can assume respective value(s) for decoding DCI, the network entity may use a second AL for sending the DCI, where the second AL corresponds to a second number of CCEs smaller than the first number of CCES and that occupy a second number of time and frequency resources less than the first number of time and frequency resources.

Further, in certain aspects, when the assumed respective value(s) are not correct, the device may again attempt to decode the DCI without assuming the respective value(s), thereby still potentially being able to decode the DCI.

In some aspects, a device receiving the DCI (e.g., a UE) can implement a tracking process which stores (e.g., in a local database and/or in one or more memories of the device) those DCI field values that are not frequently updated and/or not expected to likely differ for different scheduling grants. Subsequently, the device may use the stored DCI field values as “known DCI values” or “known values” when attempting to decode a downlink control channel candidate (e.g., PDCCH candidate), such as via a polar decoder. In some aspects, the techniques and signaling described herein may enhance usage of known DCI values by allowing a downlink control channel transmitter (e.g., a PDCCH transmitter, such as a network entity) to assume support of known DCI values in a rate adaptation process for downlink control channels. That is, the downlink control channel transmitter may use fewer resources when transmitting the downlink control channel(s) and may expect the device to use the stored DCI field values as the known DCI values when the device attempts to decode a downlink control channel candidate.

As described herein, a network entity may define and indicate (e.g., to the device) a list of DCI fields to be tracked and/or to have DCI field values assumed by the device and used as known DCI values for decoding downlink control channel candidates. In some aspects, each of the DCI fields in the list of DCI fields may be mapped to corresponding DCI formats, where the corresponding DCI formats include the DCI fields mapped to them. Additionally or alternatively, the network entity may indicate (e.g., to the device, such as via RRC signaling) configured values for one or more DCI fields, where the device uses the configured values when attempting to decode downlink control channel candidates.

In some aspects, the device may send (e.g., to the network entity) a capability flag that indicates the device supports using known DCI values when decoding downlink control channel candidates. In some aspects, the capability flag may enable the network entity to use a rate adaptation mode when sending downlink control channel candidates using the known DCI values (e.g., the network entity may adjust a code ratio of PDCCH transmissions using the known or assumed values).

Additionally or alternatively, the network entity may indicate (e.g., to the device) a monitoring window that includes a number of downlink control channel candidates for the device to decode without using the known DCI values. Subsequently, the device may assume a respective value for one or more DCI fields to be used as the known DCI values based on decoded values for each of the DCI fields remaining unchanged for the number of downlink control channel candidates.

In certain aspects, the techniques for allocating downlink channel resource(s) for a device supporting known DCI values as described herein may provide any of various beneficial effects and/or advantages. For example, decoding performance of DCI for the device may be improved with the device using assumed values (e.g., for the known DCI values) for one or more DCI fields, where the assumed values are tracked or configured by a network entity. As such, a reliability that the PDCCH candidate is successfully decoded may be improved. Additionally, the network entity may improve PDCCH channel utilization by using a lower code rate for DCI message(s) with expecting the device to use the assumed DCI field values (e.g., the known DCI values). That is, network utilization may be improved by allowing a PDCCH transmitter (e.g., the network entity) to optimize a link adaptation mechanism for using less time and frequency resources when a PDCCH receiver (e.g., the device described previously) decodes PDCCH candidates (e.g., downlink control channel candidates) with the known DCI values (e.g., partially known values of a payload of the PDCCH). In some aspects, the capability flag may enable the network entity to reduce the time and frequency resources by indicating that the device supports using the known DCI values. Additionally, the monitoring window may enable the device to determine and/or update the known DCI values without additional signaling from the network entity, thereby reducing signaling overhead, such as to indicate configured values for the known DCI values.

Additionally, the known DCI values may be used at both the network entity and the device for a PDCCH, such that expecting the device to use the known DCI values in allows the network entity to optimize network utilization by assigning a lower number of cell time and frequency resources for a PDCCH without compromising PDCCH performance. Additionally, the techniques and signaling described herein may improve cell capacity by reducing PDCCH time and frequency resources (e.g., fewer CCEs) allocated by the network for devices supporting the known DCI values.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

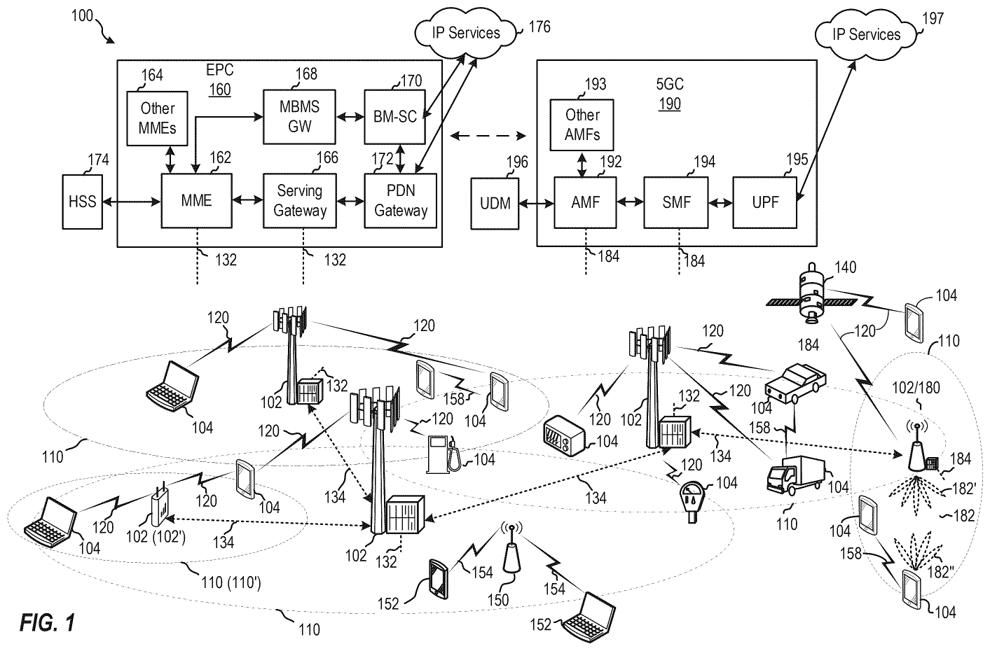

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

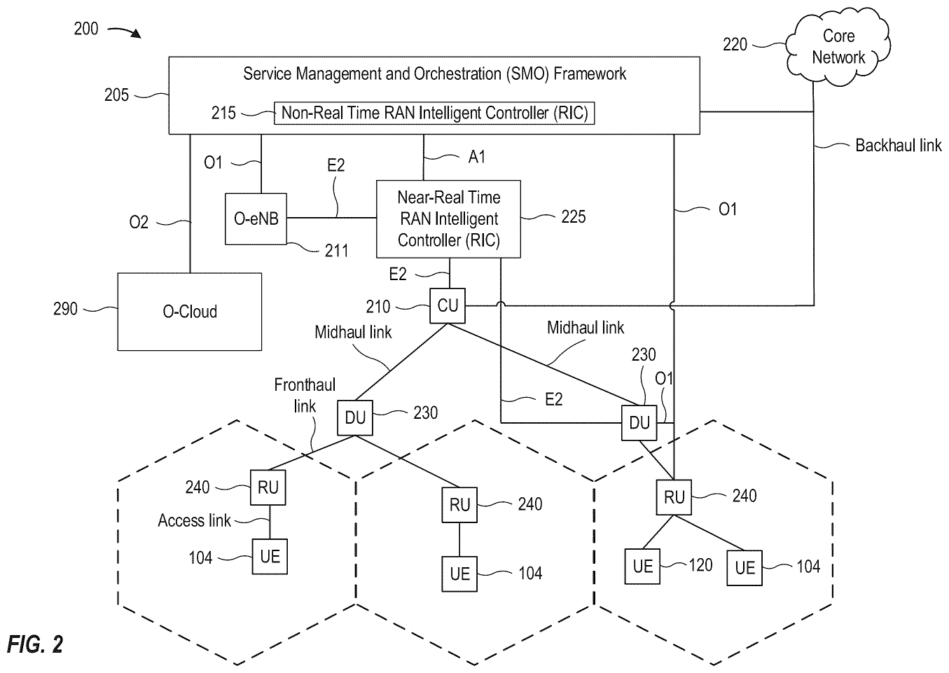

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

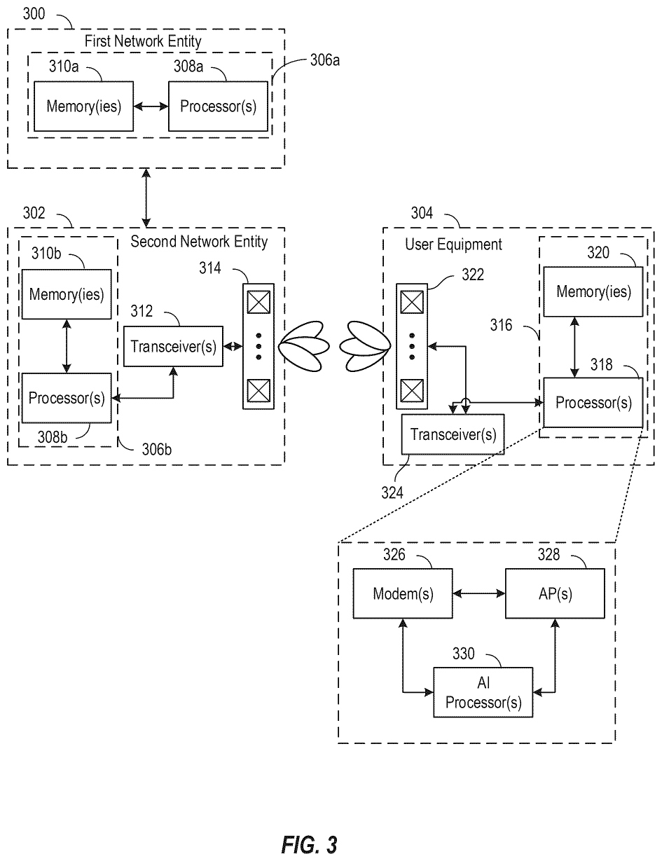

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

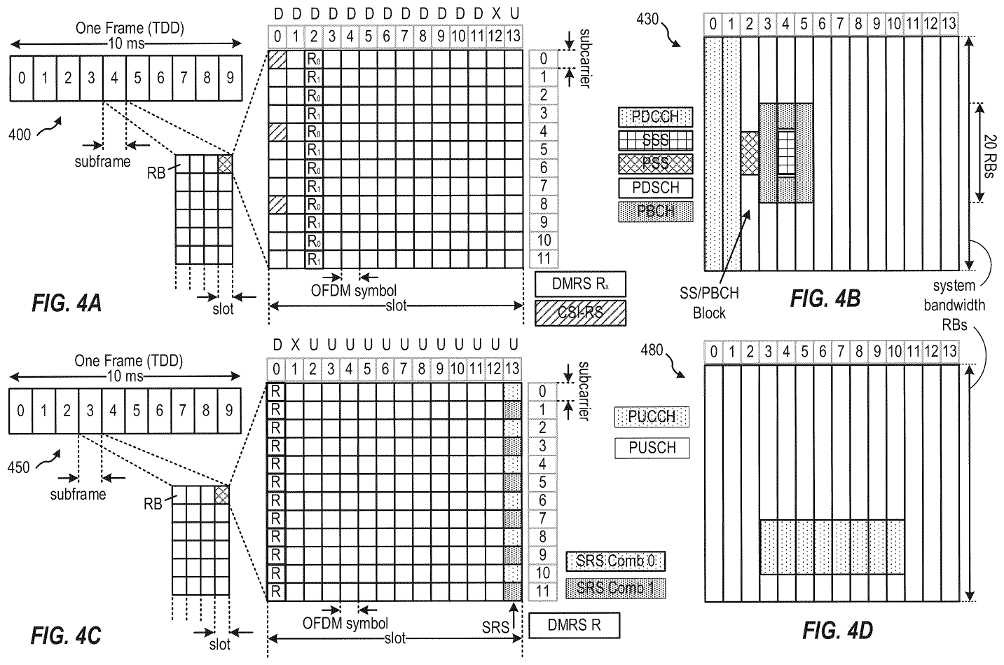

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example PDCCH Communications

FIG. 5 depicts an example scheme 500 for configuring time-frequency resources for communication of one or more PDCCHs, such as including one or more DCIs. In certain aspects, a UE may be configured with a CORESET 502, which may occupy a portion of a bandwidth part (BWP) 504 of a carrier 506 in the frequency domain. The BWP 504 may be a contiguous frequency range (e.g., resource blocks) of a channel bandwidth of the carrier 506. The carrier 506 may be a frequency range of an operating band specified for wireless communications, such as an operating band of FR1 and/or FR2. The CORESET 502 may enable flexible configuration or reconfiguration of time-frequency resources for PDCCH communications.

In the time domain, the CORESET 502 may occupy a set of symbols 508 of a slot 510 (such as the first symbol, the first two symbols, or the first three symbols). In the frequency domain, the CORESET 502 may occupy a set of resource blocks (RBs) across the BWP 504. As an example, the set of resource blocks that form the CORESET 502 may be indicated via a bit string, where each bit of the bit string may represent a set of contiguous resource blocks (e.g., 6 resource blocks) in the BWP 504. A specific set of contiguous resource blocks may be included in the CORESET 502 if the corresponding bit of the bit string is set to a particular value (e.g., a value of ‘1’).

The CORESET 502 may include one or more CCEs 512. Each CCE 512 may be formed from a certain number of resource element groups (REGs) 514, such as a total of six REGs. As an example, a REG 514 may occupy a single resource block 516 (e.g., multiple REs 518) in the frequency domain and a single symbol in the time domain. The total number of CCEs 512 used to communicate a PDCCH may be referred to as an AL. Various ALs may be used, such as 1, 2, 4, 8, 16, and/or the like. As an example, at an AL of 1, a single CCE 512 may be used to communicate a PDCCH. At an AL of 2, two CCEs 512 may be used to communicate a PDCCH, for example, with greater redundancy than the redundancy used for the AL of 1, and so on for the other ALs (e.g., 4, 8, and 16). Thus, the AL may also correspond to the code rate (e.g., the level of redundancy information included in the payload of a PDCCH) used to encode the PDCCH. The AL may accommodate the PDCCH and the DMRS for the PDCCH. For example, the DMRS may occupy a portion of the resource elements used by the PDCCH, such as 25% of the resource elements. The resource elements for the DMRS may be located in certain positions across the AL of the PDCCH.

An SS may include all possible locations (e.g., in time and/or frequency) where a PDCCH may be located. A CORESET may include one or more SSs, such as a UE-specific SS, a group-common SS, and/or a common SS. An SS may indicate a set of CCEs where a UE may perform blind decoding to find a PDCCH that carries control information (e.g., DCI) for the UE. The possible locations for a PDCCH may depend on whether the PDCCH is a UE-specific PDCCH (e.g., for a single UE) or a group-common PDCCH (e.g., for multiple UEs), an AL being used, and/or the like. A possible location (e.g., in time and/or frequency) for a PDCCH may be referred to as a PDCCH candidate, and the set of all possible PDCCH locations may be referred to as an SS. For example, the set of all possible PDCCH locations for a particular UE may be referred to as a UE-specific SS. Similarly, the set of all possible PDCCH locations across all UEs may be referred to as a common SS. The set of all possible PDCCH locations for a particular group of UEs may be referred to as a group-common SS.

A CORESET may be non-interleaved or interleaved. A non-interleaved CORESET may have a CCE-to-REG mapping such that all CCEs are mapped to consecutive REG bundles (e.g., in the frequency domain) of the CORESET. For example, a CCE may be formed from a bundle of 6 consecutively numbered REGs, and the REG numbering may increase with time and then increase with frequency. An interleaved CORESET may have CCE-to-REG mapping such that a CCE may be formed from one or more REG bundles (e.g., a set of REGs), which may be interleaved in the frequency domain. In certain aspects, the CORESET may rotate the CCE numbering based on an interleaver depth.

Note that FIG. 5 is provided as an example to facilitate an understanding of PDCCH communications. Other examples may differ from what is described with respect to FIG. 5.

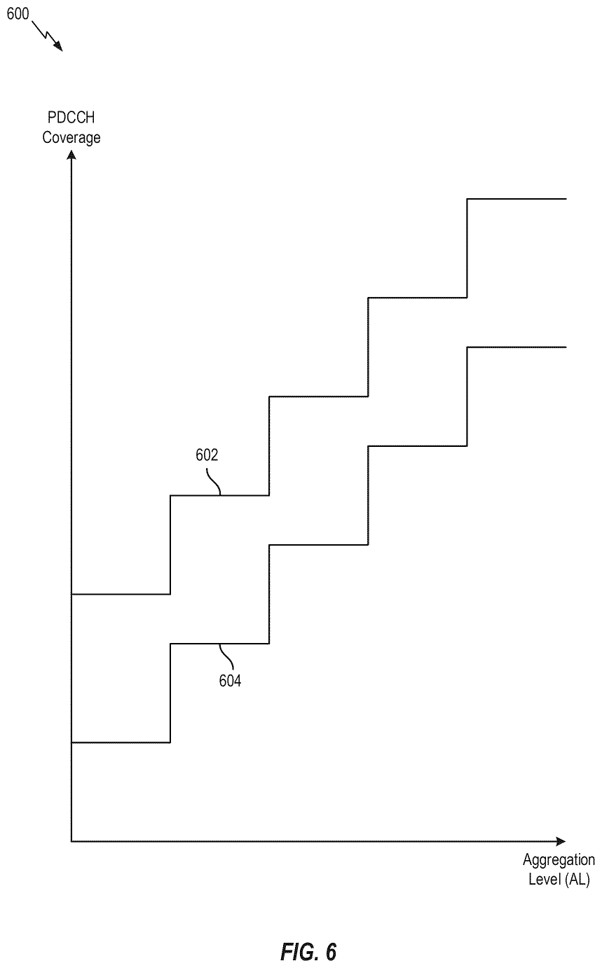

FIG. 6 depicts an example association 600 between AL and downlink channel coverage (e.g., PDCCH coverage) for different DCI payload sizes. In the example of FIG. 6, the association 600 is depicted for a first DCI message 602 and a second DCI message 604. In some aspects, the first DCI message 602 may include a first payload size, and the second DCI message 604 may include a second payload size, where the second payload size is greater than the first payload size.

For a given DCI payload size, higher ALs may increase a robustness of a PDCCH transmission that includes the DCI payload (e.g., PDCCH coverage increases for higher ALs) but may consume more CCEs (e.g., a higher amount of time and frequency resources), thus reducing a total cell capacity. For example, for both the first payload size (e.g., for the first DCI message 602) and the second payload size (e.g., for the second DCI message 604), PDCCH coverage increases as ALs increase, but higher ALs correspond to higher numbers of CCEs (e.g., as described with reference to FIG. 5), where the higher numbers of CCEs occupy more time and frequency resources compared to lower ALs and fewer CCEs. Additionally or alternatively, lower ALs may consume fewer time and frequency resources (e.g., based on fewer CCEs being configured in an SS) but may decrease robustness and coverage of the PDCCH transmission, which may reduce a reliability that the PDCCH transmission is successfully received and decoded by corresponding devices.

In some aspects, reducing a payload size of a DCI message may increase a code ratio of the PDCCH transmission (e.g., ratio of information bits to the total number of bits transmitted in the PDCCH, including information and redundant bits), thereby achieving high PDCCH performance (e.g., high robustness and PDCCH coverage) with lower ALs (e.g., fewer CCEs and/or time and frequency resources). For example, if a network entity is able to decrease a payload size of a DCI message (e.g., from the second payload size depicted for the second DCI message 604 to the first payload size depicted for the first DCI message 602), the network entity may still achieve high PDCCH coverage while lowering an AL needed for the decreased payload size for the DCI message. That is, the network entity may utilize fewer time and frequency resources for sending the decreased payload size (e.g., based on the lower AL and/or fewer bits to be sent) and may still achieve high PDCCH coverage. As shown in the example of FIG. 6, the first DCI message 602 (e.g., with the first payload size that is smaller than the second payload size) may achieve higher PDCCH coverage than the second DCI message 604 with lower ALs than the second DCI message 604.

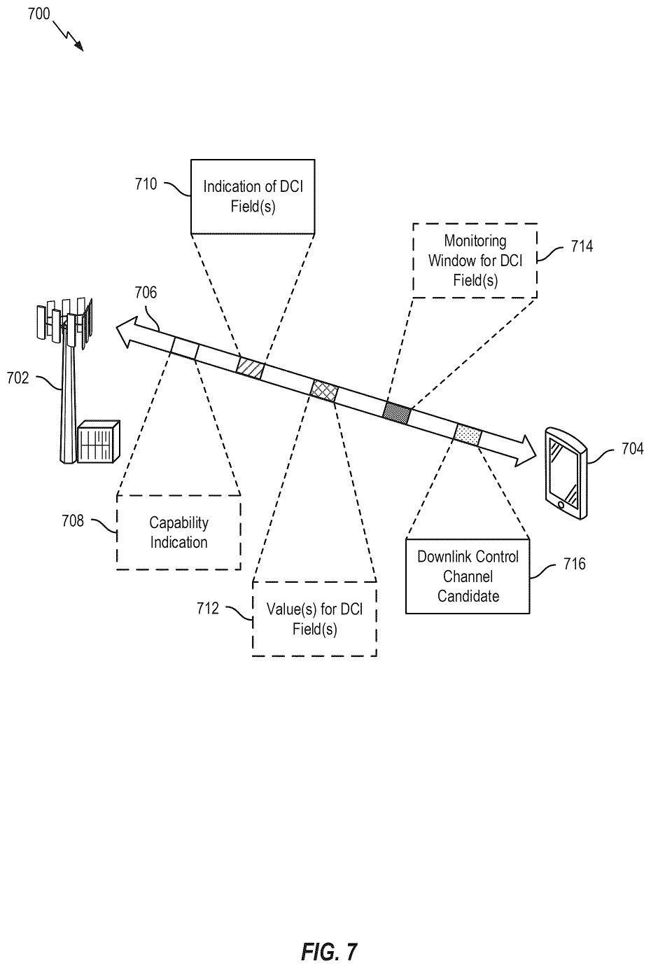

Accordingly, as will be described in greater detail with reference to FIG. 7, the network entity may leverage DCI field values that are not frequently updated and/or not expected to likely differ for one or more DCI messages to use a smaller AL (e.g., fewer CCEs) for allocating downlink channel resource(s) for the DCI message(s). For example, the DCI field values that are not frequently updated and/or not expected to likely differ for one or more DCI messages may be referred to as “known DCI values,” “known values,” “partially known payload values of a PDCCH,” “known DCI payload values,” etc. Subsequently, the network entity may use fewer time and frequency resources (e.g., fewer CCEs according to the smaller AL) when transmitting the DCI message(s) and may expect a receiving device to use stored values for the DCI field values that are not frequently updated and/or not expected to likely differ as known DCI values when the device attempts to decode a PDCCH candidate. Accordingly, a total cell capacity may be increased (e.g., based on the network entity using fewer time and frequency resources to send one or more DCI messages), and a reliability that the PDCCH candidate is successfully decoded may be maintained or improved (e.g., a coverage of the PDCCH candidate remains high even though fewer time and frequency resources are used for the PDCCH candidate).

### Aspects Related to Decoding DCI Based on Assuming DCI Field Values

FIG. 7 depicts an example wireless communications network 700 that supports decoding DCI assuming one or more values for one or more fields of the DCI (e.g., DCI field values) in accordance with aspects of the present disclosure. In some examples, the wireless communications network 700 may implement aspects of or may be implemented by aspects of FIG. 1-6. For example, the wireless communications network 700 may include a network entity 702 and at least one device 704. In certain aspects, the network entity 702 represents a base station or similar network entity as described with reference to FIG. 1-3 (e.g., BS 102, first network entity 300, second network entity 302, etc.). In certain aspects, the device 704 represents a UE or similar terminal device as described with reference to FIG. 1-3 (e.g., UE 104, UE 304, etc.). Additionally, the wireless communications network 700 may support communication between the network entity 702 and the device 704. For example, the network entity 702 and the device 704 may wirelessly communicate via a communication link 706 (e.g., one or more carriers, a communication link 120, etc.). While only one device 704 is depicted in the example of FIG. 7, the network entity 702 may communicate with multiple devices and/or UEs.

In some aspects, the network entity 702 (e.g., downlink control channel transmitter) may use a rate adaptation process (e.g., a process to dynamically adapt a code rate) when sending one or more downlink control channel(s) with fewer time and frequency resources (e.g., using a lower AL). As described herein, the network entity may expect the device to use stored DCI field values as known DCI values when the device 704 attempts to decode a downlink control channel candidate (e.g., a PDCCH candidate). To use the stored DCI field values when attempting to decode the downlink control channel candidate, the network entity 702 and the device 704 may exchange one or more signals and/or configuration parameters (e.g., via the communication link 706).

In some aspects, the network entity 702 may send (e.g., to the device 704, such as via the communication link 706) an indication 710 that includes a list of DCI fields to be tracked by the device 704 and used as known DCI values for decoding downlink control channel candidates. For example, the indication 710 may include an RRC configuration that defines the list of DCI fields. Accordingly, the device 704 may assume values for each DCI field in the list of DCI fields based on tracking the DCI fields over time. For example, the device 704 may determine values for each DCI field in the list of DCI fields based on tracking values for each DCI field, and the device 704 may then store the values as assumed values for each DCI field in the list of DCI fields (e.g., in a local database, in one or more memories of the device 704, etc.). In some aspects, the device 704 may decode a downlink control channel candidate without using assumed values for the list of DCI fields to identify values for each DCI field.

In some aspects, the indication 710 may configure the device 704 to track one or more DCI field values that the device 704 uses for assumed values when decoding downlink control channel candidates with known DCI values. Additionally, each DCI field in the list of DCI fields may be mapped to one or more DCI formats. That is, DCI messages may be sent using one or more defined DCI formats, such as being defined in wireless standards, and each of the DCI formats may include multiple DCI fields. As such, the DCI fields in the list of DCI fields may correspond to one or more of the DCI formats (e.g., the one or more DCI formats include one or more DCI fields in the list of DCI fields. Subsequently, the device 704 may decode downlink control channel candidates not mapped to one of the DCI formats enabled and/or indicated with the list of DCI fields once without using any known DCI values. For example, if a downlink control channel candidate includes a DCI message that is sent using a DCI format that does not include any of the DCI fields in the list of DCI fields, then the device 704 may attempt to decode that DCI message without assuming values for any of the DCI fields of the corresponding DCI format.

Additionally or alternatively, the device 704 may optionally send a capability indication 708 (e.g., to the network entity 702, such as via the communication link 706) that indicates a capability of the device 704 (e.g., UE capability) for supporting known DCI values. In some aspects, the capability indication 708 may include a device capability flag (e.g., exchanged through an RRC connection) that enables the network entity 702 to expect that the device 704 will use the known DCI values when attempting to decode DCI message(s). Additionally or alternatively, the network entity may use a downlink control channel rate adaptation mode when sending the DCI message(s) when the device 704 indicates support of using known DCI values in the capability indication 708. Additionally, the network entity 702 may send the indication 710 based on receiving the capability indication 708 (e.g., the network entity 702 indicates DCI fields to be tracked by the device 704 if the device 704 has the capability for supporting known DCI values).

In some aspects, devices that send and/or declare the capability indication 708 may attempt to decode downlink control channel candidates twice. For example, the device 704 may attempt to decode a downlink control channel candidate once using known DCI values in a downlink control channel decoder (e.g., PDCCH decoder of the device 704) and another time without using known DCI values. In some aspects, the device 704 may attempt to decode the downlink control candidate with and without assuming DCI values to determine whether the known DCI values that are used for the assumed values are accurate and/or to provide redundancy. For example, the device 704 may compare decoding results when using the known DCI values and when not using the known DCI values to ensure that the known DCI values are accurate, such that if the decoding results are different, then the device may determine that the known DCI values are inaccurate. Additionally or alternatively, if the device 704 fails to decode the downlink control channel candidate when using the known DCI values, then the device may still be able to decode the downlink control channel candidate successfully without using the known DCI values.

In some aspects, the network entity 702 (e.g., PDCCH transmitter on the network side) may assign lower time and frequency resources when sending downlink control channel candidate(s) if DCI is assumed to be partially known (e.g., known DCI values) by the device 704 (e.g., UE receiver). For example, based on channel conditions and before encoding and rate-matching DCI for a downlink control channel candidate, the network entity may determine which AL to use in a current transmission (e.g., current PDCCH transmission). If known DCI values is enabled, the network entity 702 may determine to use a lower AL when sending a downlink control channel, which saves time and frequency resources (e.g., at least half an amount of time and frequency resources compared to when known DCI values is not enabled).

Additionally or alternatively, the network entity 702 may optionally configure one or more values 712 for DCI fields (e.g., from the list of DCI fields indicated in the indication 710). For example, the network entity 702 may send the one or more values 712 via semi-static signaling, such as RRC signaling. The one or more values 712 may allow the network entity 702 to provide an optional static configuration for one or more DCI fields enabled by the indication 710 of the list of DCI fields. In some wireless communications networks (e.g., industrial Internet of Things (IOT) communications network), a link adaptation may not be used because link parameters are not expected change for communications, and one or more DCI fields (e.g., MCS, antenna port, etc.) may remain constant for different scheduling grants. Accordingly, the network entity may configure the one or more values 712 and indicate the one or more values 712 to the device 704 for the device 704 to use when attempting to decode a downlink control channel candidate.

In some aspects, the network entity 702 may use the one or more values 712 to configure most-likely used values for the known DCI values and to disable DCI field tracking at the device 704 for the one or more values 712. Additionally or alternatively, the device 704 may use the one or more values 712 in addition to tracking DCI field values when attempting to decode a downlink control channel candidate, such that the device 704 uses the one or more values 712 and tracks DCI field values for DCI fields that are not included in the one or more values 712. Additionally or alternatively, the device 704 may track the DCI field values and may not use the one or more values 712. For example, the device 704 may be configured with the list of DCI values to track over time via the indication 710 and then may use the tracked values when assuming values for the known DCI values. That is, the device 704 may look at a number of previous decodes of downlink control channel candidates and may track the DCI field values across the number of previous decodes to determine assumed values for those DCI fields. In some aspects, the device 704 may switch between tracking DCI field values, using the one or more values 712, and the combination of both tracking the DCI field values and using the one or more values 712 when attempting to decode downlink control channel candidates.

In some aspects, the network entity 702 may indicate (e.g., to the device 704, such as via the communication link 706) a monitoring window 714 for DCI fields indicated in the list of DCI fields of the indication 710. For example, the monitoring window 714 may define how many DCI message(s) (e.g., a number of DCI messages, N) to be decoded and/or processed by the device 704 (e.g., without known DCI values) before the network entity 702 can start using known DCI values when sending downlink control channel candidates. That is, if the number of DCI messages to be decoded and/or processed by the device 704 for the monitoring window 714 is greater than 1 (e.g., N>1), the device 704 may determine values for the DCI fields (e.g., known DCI values) if the last N decoded DCI messages had unchanged values for each DCI field of the list of DCI fields indicated in the indication 710 (e.g., DCI fields enabled for known DCI values monitoring and/or tracking for the device 704). Additionally or alternatively, the network entity may configure the number of DCI messages to be decoded and/or processed by the device 704 for the monitoring window 714 to be 1 (e.g., N=1) to indicate for the device 704 to use values for the list of DCI fields (e.g., known DCI values) from a last received and successfully decoded DCI payload.

In some aspects, the network entity 702 may configure the number of DCI messages to be decoded and/or processed by the device 704 for the monitoring window 714 via RRC signaling. In certain aspects, the device 704 may ignore the monitoring window 714 for DCI fields that have been semi-statically configured with the one or more values 712. In some aspects, the monitoring window 714 may be referred to as a known DCI fields update window, where the device 704 updates values for one or more DCI fields in the list of DCI fields indicated by the indication 710 (e.g., updates known DCI values) based on the number of DCI messages to be decoded and/or processed by the device 704 (e.g., using values from a last received and successfully decoded DCI payload if N=1 and/or unchanged values from the last N decoded DCI message(s) if N>1).

Subsequently, the network entity 702 may send a downlink control channel candidate 716 (e.g., to the device 704, such as via the communication link 606, and/or to other devices), and the device 704 may attempt to decode the downlink control channel candidate 716 to obtain DCI based on the known DCI values. In some aspects, the device 704 may obtain the DCI based on a successful decode of the downlink control channel candidate 716, where the DCI obtained based on the known DCI values.

### Example Signaling Related to Decoding DCI Based on Assuming DCI Field Values

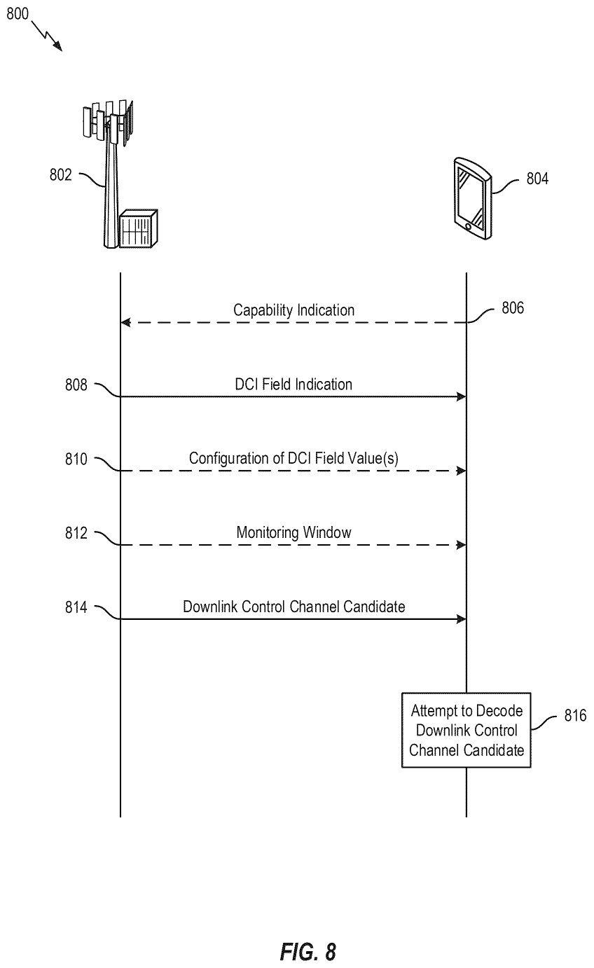

FIG. 8 depicts a process flow 800 for communications in a network between a network entity 802 and a device 804 of downlink channels based on known DCI values. For example, the process flow 800 may represent communications for decoding DCI assuming one or more values for one or more fields of the DCI (e.g., DCI field values) as described herein. In some aspects, the network entity 802 may be an example of a BS 102 depicted and described with respect to FIG. 1, a first network entity 300 or second network entity 302 depicted and described with respect to FIG. 3, a disaggregated base station depicted and described with respect to FIG. 2, or a network entity 702 as described with reference to FIG. 7. Similarly, the device 804 may be an example of a UE 104 depicted and described with respect to FIG. 1, a UE 304 depicted and described with respect to FIG. 3, or a device 704 depicted and described with respect to FIG. 7. However, in other aspects, the device 804 may be another type of wireless communications device, and the network entity 802 may be another type of network entity or network node, such as those described herein. Note that any operations or signaling illustrated with dashed lines may indicate that that operation or signaling is an optional or alternative example.

At 806, the device 804 may send (e.g., to the network entity 802) an indication of a capability of the device 804 (e.g., the capability indication 708 as described with reference to FIG. 7) that indicates a support for assumption of a respective value for each of one or more DCI fields. In some aspects, the indication of the capability of the device 804 may include a capability flag indication.

At 808, the device 804 receives (e.g., from the network entity 802) an indication of one or more DCI fields (e.g., the indication 710 as described with reference to FIG. 7) that indicates for the device 804 to assume a respective value for each of the one or more DCI fields (e.g., known DCI values as described herein) to attempt to decode a downlink control channel candidate. For example, the device 804 may receive the indication of the one or more DCI fields via RRC signaling. In some aspects, the device 804 may receive the indication for assuming the respective value for each of the one or more DCI fields based on the capability of the device 804 sent in the indication at 806. Additionally, the device 804 may store the respective value for each of the one or more DCI fields in a local database, in one or more memories, or a combination thereof.

At 810, the device 804 may receive an indication of a configuration of the respective value for each of the one or more DCI fields (e.g., the one or more values 712 as described with reference to FIG. 7). In some aspects, the device 804 may receive the indication of the configuration via RRC signaling. Additionally, the indication of the configuration of the respective values may be a part of the signaling at 808 (e.g., the indication of the one or more DCI fields) or may include separate signaling.

At 812, the device 804 may receive an indication of a monitoring window (e.g., the monitoring window 714 as described with reference to FIG. 7) indicating a number of downlink control channel candidates to decode without assumption of the respective value for each of the one or more DCI fields and may assume the respective value for each of the one or more DCI fields for subsequent attempts to decode one or more downlink control channel candidates after the number of downlink control channel candidates. For example, the device 804 may assume the respective value for each of the one or more DCI fields based on decoded values for each of the one or more DCI fields comprising unchanged values for the number of downlink control channel candidates. Additionally or alternatively, the device 804 may receive the indication of the configuration of the one or more values for the one or more respective DCI fields (e.g., at 810) and may use the one or more values for the one or more respective DCI fields when attempting to decode the downlink control channel candidate after the number of downlink control channel candidates. Additionally, the indication of the monitoring window may be a part of the signaling at 808 (e.g., the indication of the one or more DCI fields) or may include separate signaling.

At 814, the network entity 802 sends (e.g., to the device 804 and/or other devices), the downlink control channel candidate (e.g., the downlink control channel candidate 716 as described with reference to FIG. 7). In some aspects, the network entity 802 may send a previous downlink control channel candidate prior to the downlink control channel candidate via a first set of time-frequency resources (e.g., using a first AL that corresponds to a first number of CCEs) based on not expecting the device 804 to assume values for the one or more DCI fields. Subsequently, the network entity 802 may send the downlink control channel candidate via a second set of time-frequency resources (e.g., using a second AL that corresponds to a second number of CCEs that is less than the first number of CCEs) based on an assumption of the respective value for each of the one or more DCI fields by the device 804, and the second set of time-frequency resources may include fewer time-frequency resources than the first set of time-frequency resources.

At 816, the device 804 attempts to decode the downlink control channel candidate to obtain DCI based on the respective value for each of the one or more DCI fields. For example, the device 804 may obtain the DCI based on a successful decode of the downlink control channel candidate, where the DCI is obtained based on the respective value for each of the one or more DCI fields (e.g., stored in the local database, one or more memories, etc.). In some aspects, the device 804 may attempt to decode the downlink control channel candidate without assumption of the respective value for each of the one or more DCI fields.

In some aspects, the one or more DCI fields may be mapped to one or more DCI formats, and the device 804 may attempt to decode one or more downlink control channel candidates without assumption of the respective value for each of the one or more DCI fields based on the one or more downlink control channel candidates including a DCI format not included in the one or more DCI formats. For example, if the one or more downlink control channel candidates include a DCI message that is sent using a DCI format that does not include any of the DCI fields in the list of DCI fields, then the device 804 may attempt to decode that DCI message without assuming values for any of the DCI fields of the corresponding DCI format.

Note that the process flow illustrated in FIG. 8 is an example of a decoding DCI, and aspects of the present disclosure may be applied to decoding DCI based on assuming one or more DCI field values. Note that the process flow illustrated in FIG. 8 is described herein to facilitate an understanding of decoding DCI based on assuming one or more DCI field values, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a User Equipment

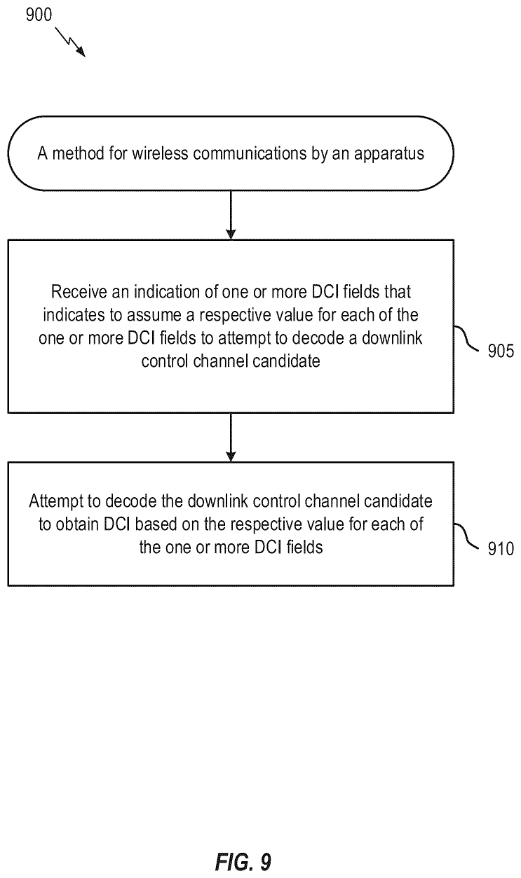

FIG. 9 shows a method 900 for wireless communications by an apparatus, such as UE 104 of FIG. 1 or UE 304 of FIG. 3.

Method 900 begins at block 905 with receiving an indication of one or more DCI fields (e.g., the indication 710 as described with reference to FIG. 7) that indicates to assume a respective value for each of the one or more DCI fields to attempt to decode a downlink control channel candidate.

Method 900 then proceeds to block 910 with attempting to decode the downlink control channel candidate (e.g., the downlink control channel candidate 716 as described with reference to FIG. 7) to obtain DCI based on the respective value for each of the one or more DCI fields.

In one aspect, method 900 further includes receiving an indication of a configuration of the respective value for each of the one or more DCI fields (e.g., the one or more values 712 as described with reference to FIG. 7).

In one aspect, method 900 further includes receiving the indication of the configuration via RRC signaling.

In one aspect, method 900 further includes sending an indication of a capability of the apparatus (e.g., the capability indication 708 as described with reference to FIG. 7) that indicates a support for assumption of the respective value for each of the one or more DCI fields.

In one aspect, the indication of the capability of the apparatus comprises a capability flag indication.

In one aspect, method 900 further includes obtaining the DCI based on a successful decode of the downlink control channel candidate, the DCI obtained based on the respective value for each of the one or more DCI fields.

In one aspect, method 900 further includes attempting to decode the downlink control channel candidate without assumption of the respective value for each of the one or more DCI fields.

In one aspect, method 900 further includes receiving an indication of a monitoring window (e.g., the monitoring window 714 as described with reference to FIG. 7) indicating a number of downlink control channel candidates to decode without assumption of the respective value for each of the one or more DCI fields.

In one aspect, method 900 further includes assuming the respective value for each of the one or more DCI fields for subsequent attempts to decode one or more downlink control channel candidates after the number of downlink control channel candidates.

In one aspect, method 900 further includes assuming the respective value for each of the one or more DCI fields based on decoded values for each of the one or more DCI fields comprising unchanged values for the number of downlink control channel candidates.

In one aspect, method 900 further includes receiving an indication of a configuration of one or more values for one or more respective DCI fields of the one or more DCI fields.

In one aspect, method 900 further includes attempting to decode the downlink control channel candidate after the number of downlink control channel candidates based on the one or more values.

In one aspect, the one or more DCI fields are mapped to one or more DCI formats.

In one aspect, method 900 further includes attempting to decode one or more downlink control channel candidates without assumption of the respective value for each of the one or more DCI fields based on the one or more downlink control channel candidates comprising a DCI format not included in the one or more DCI formats.

In one aspect, method 900 further includes receiving the indication of the one or more DCI fields via RRC signaling.

In one aspect, method 900 further includes storing the respective value for each of the one or more DCI fields in a local database, the one or more memories, or a combination thereof.

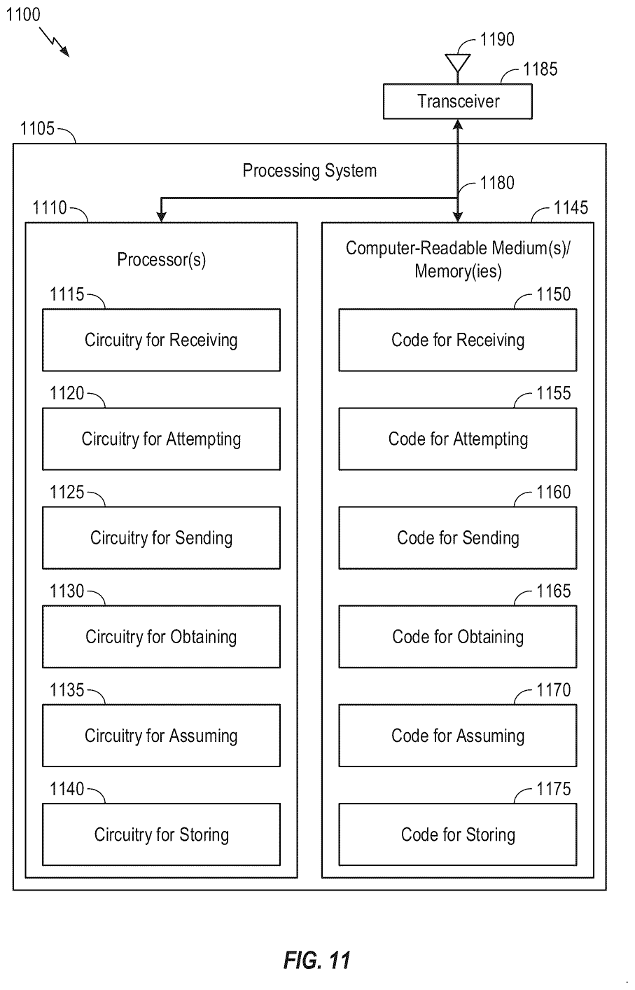

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

In certain aspects, method 900 may be performed by the apparatus to realize one or more technical effects or solutions to the aforementioned technical problem(s). For example, based on method 900, channel utilization for a downlink control channel may be improved by the network entity using a lower code rate for DCI message(s) with predictable data fields (e.g., the respective value for each of the one or more DCI fields). That is, network utilization may be improved by allowing the network entity (e.g., a downlink control channel transmitter) to optimize a link adaptation mechanism for using less time and frequency resources when the apparatus (e.g., a downlink control channel receiver) decodes downlink control channel candidates with the respective value for each of the one or more DCI fields. Additionally, the respective value for each of the one or more DCI fields (e.g., known DCI values) may be used in both a transmitter chain at the network entity and a receiver chain at the apparatus, such that using the respective value for each of the one or more DCI fields in the receiver chain allows the network entity to optimize network utilization by assigning a lower number of cell time and frequency resources for a downlink control channel without compromising performance of the downlink control channel (e.g., without reducing coverage of the downlink control channel). Additionally, cell capacity may be improved by reducing time and frequency resources allocated by the apparatus for the downlink control channel for devices supporting the known DCI values (e.g., devices that have a capability for supporting known PDCCH values).

### Example Operations of a Network Entity

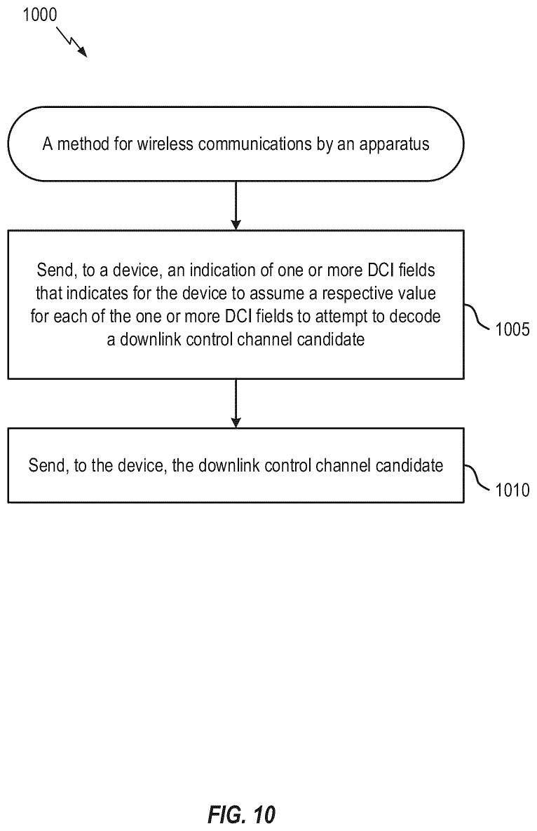

FIG. 10 shows a method 1000 for wireless communications by an apparatus, such as BS 102 of FIG. 1, a first network entity 300 or second network entity 302 of FIG. 3, or a disaggregated base station as discussed with respect to FIG. 2.

Method 1000 begins at block 1005 with sending, to a device, an indication of one or more DCI fields (e.g., the indication 710 as described with reference to FIG. 7) that indicates for the device to assume a respective value for each of the one or more DCI fields to attempt to decode a downlink control channel candidate.

Method 1000 then proceeds to block 1010 with sending, to the device, the downlink control channel candidate (e.g., the downlink control channel candidate 716 as described with reference to FIG. 7).

In certain aspects, method 1000 further includes sending an indication of a configuration of the respective value for each of the one or more DCI fields (e.g., the one or more values 712 as described with reference to FIG. 7).

In certain aspects, method 1000 further includes sending the indication of the configuration via RRC signaling.

In certain aspects, method 1000 further includes receiving an indication of a capability of the device (e.g., the capability indication 708 as described with reference to FIG. 7) that indicates a support of the device for assumption of the respective value for each of the one or more DCI fields.

In one aspect, the indication of the capability of the device comprises a capability flag indication.

In certain aspects, method 1000 further includes sending a previous downlink control channel candidate prior to the downlink control channel candidate via a first set of time-frequency resources.

In certain aspects, method 1000 further includes sending the downlink control channel candidate via a second set of time-frequency resources based on an assumption of the respective value for each of the one or more DCI fields by the device, the second set of time-frequency resources comprising fewer time-frequency resources than the first set of time-frequency resources.

In certain aspects, method 1000 further includes sending, to the device, an indication of a monitoring window (e.g., the monitoring window 714 as described with reference to FIG. 7) indicating a number of downlink control channel candidates for the device to decode without assumption of the respective value for each of the one or more DCI fields.

In one aspect, the one or more DCI fields are mapped to one or more DCI formats.

In certain aspects, method 1000 further includes sending the indication of the one or more DCI fields via RRC signaling.

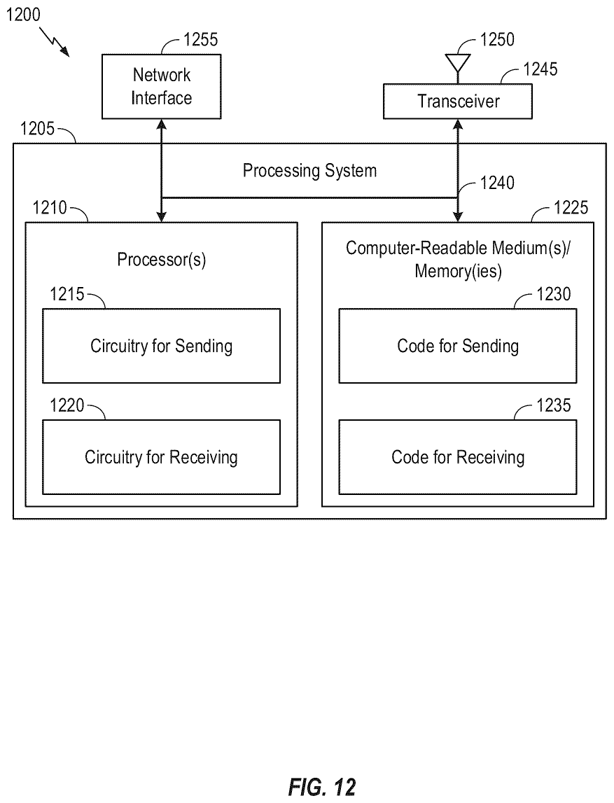

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the apparatus may improve channel utilization for a downlink control channel by using a lower code rate for DCI message(s) with predictable data fields (e.g., the respective value for each of the one or more DCI fields). That is, network utilization may be improved by allowing the apparatus (e.g., a downlink control channel transmitter) to optimize a link adaptation mechanism for using less time and frequency resources when a downlink control channel receiver (e.g., the device) decodes downlink control channel candidates with the respective value for each of the one or more DCI fields. Additionally, the respective value for each of the one or more DCI fields (e.g., known DCI values) may be used in both a transmitter chain at the apparatus and a receiver chain at the device, such that using the respective value for each of the one or more DCI fields in the receiver chain allows the apparatus to optimize network utilization by assigning a lower number of cell time and frequency resources for a downlink control channel without compromising performance of the downlink control channel (e.g., without reducing coverage of the downlink control channel). Additionally, cell capacity may be improved by reducing time and frequency resources allocated by the apparatus for the downlink control channel for devices supporting the known DCI values (e.g., devices that have a capability for supporting known PDCCH values).

### Example Communications Devices

FIG. 11 depicts aspects of an example communications device 1100. In some aspects, communications device 1100 is a user equipment, such as UE 104 described above with respect to FIG. 1 or UE 304 described with respect to FIG. 3.

The communications device 1100 includes a processing system 1105 coupled to a transceiver 1185 (e.g., a transmitter and/or a receiver). The transceiver 1185 is configured to transmit and receive signals for the communications device 1100 via an antenna 1190, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1145. In various aspects, the one or more processors 1110 may be representative of one or more of the one or more processors 318 described with respect to FIG. 3. The one or more processors 1110 are coupled to the computer-readable medium/memory 1145 via a bus 1180. In some aspects, the computer-readable medium/memory 1145 may be representative of the one or more memories 320 described with respect to FIG. 3. The computer-readable medium/memory 1145 is a non-transitory computer-readable medium/memory. In certain aspects, the computer-readable medium/memory 1145 is configured to store instructions (e.g., computer-executable code), including code 1150-1175, that when executed by the one or more processors 1110, enable and cause the one or more processors 1110 to perform the method 900 described with respect to FIG. 9, or any aspect related to the method 900, including any operations described in relation to FIG. 9. Note that reference to a processor performing a function of communications device 1100 may include one or more processors performing that function of communications device 1100, such as in a distributed fashion.

In the depicted example, computer-readable medium/memory 1145 stores code (e.g., executable instructions) for receiving 1150, code for attempting 1155, code for sending 1160, code for obtaining 1165, code for assuming 1170, and code for storing 1175. Processing of the code 1150-1175 may enable and cause the communications device 1100 to perform the method 900 described with respect to FIG. 9, or any aspect related to the method 900.

The one or more processors 1110 include circuitry configured to implement (e.g., execute) the code stored in the computer-readable medium/memory 1145, including circuitry for receiving 1115, circuitry for attempting 1120, circuitry for sending 1125, circuitry for obtaining 1130, circuitry for assuming 1135, and circuitry for storing 1140. Processing with circuitry 1115-1140 may enable and cause the communications device 1100 to perform the method 900 described with respect to FIG. 9, or any aspect related to the method 900.

More generally, means for communicating, transmitting, sending or outputting for transmission may include the one or more transceivers 324, one or more antennas 322, and/or processing system 316 of the UE 304 illustrated in FIG. 3, transceiver 1185 and/or antenna 1190 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1185 and/or antenna 1190 of the communications device 1100 in FIG. 11, and/or one or more processors 1110 of the communications device 1100 in FIG. 11.

FIG. 12 depicts aspects of an example communications device 1200 configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1205 coupled to a transceiver 1245 (e.g., a transmitter and/or a receiver) and/or a network interface 1255. The transceiver 1245 is configured to transmit and receive signals for the communications device 1200 via an antenna 1250, such as the various signals as described herein. The network interface 1255 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1225. In various aspects, one or more processors 1210 may be representative of the one or more processors 308, as described with respect to FIG. 3. The one or more processors 1210 are coupled to the computer-readable medium/memory 1225 via a bus 1240. In certain aspects, the computer-readable medium/memory 1225 is configured to store instructions (e.g., computer-executable code), including code 1230 and 1235, that when executed by the one or more processors 1210, enable and cause the one or more processors 1210 to perform the method 1000 described with respect to FIG. 10, or any aspect related to the method 1000, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1225 stores code (e.g., executable instructions) for sending 1230 and code for receiving 1235. Processing of the code 1230 and 1235 may enable and cause the communications device 1200 to perform the method 1000 described with respect to FIG. 10, or any aspect related to the method 1000.

The one or more processors 1210 include circuitry configured to implement (e.g., execute) the code (e.g., executable instructions) stored in the computer-readable medium/memory 1225, including circuitry for sending 1215 and circuitry for receiving 1220. Processing with circuitry 1215 and 1220 may enable and cause the communications device 1200 to perform the method 1000 described with respect to FIG. 10, or any aspect related to the method 1000.

Various components of the communications device 1200 may provide means for performing the method 1000 described with respect to FIG. 10, or any aspect related to the method 1000. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1245, antenna 1250, and/or network interface 1255 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1245, antenna 1250, and/or network interface 1255 of the communications device 1200 in FIG. 12, and/or one or more processors 1210 of the communications device 1200 in FIG. 12. For example, means for sending of the method 1000 described with respect to FIG. 10, or any aspect related to it, may include the one or more transceivers 312, one or more antennas 314, and/or processing system 306 of the first network entity 300 or the second network entity 302 illustrated in FIG. 3, transceiver 1245, antenna 1250, and/or network interface 1255 of the communications device 1200 in FIG. 12, and/or one or more processors 1210 of the communications device 1200 in FIG. 12.

### Example Clauses

Implementation examples are described in the following numbered clauses:
Clause 1: A method for wireless communications by an apparatus comprising: receiving an indication of one or more DCI fields that indicates to assume a respective value for each of the one or more DCI fields to attempt to decode a downlink control channel candidate; and attempting to decode the downlink control channel candidate to obtain DCI based on the respective value for each of the one or more DCI fields.
Clause 2: The method of Clause 1, further comprising receiving an indication of a configuration of the respective value for each of the one or more DCI fields.
Clause 3: The method of Clause 2, further comprising receiving the indication of the configuration via RRC signaling.
Clause 4: The method of any one of Clauses 1-3, further comprising sending an indication of a capability of the apparatus that indicates a support for assumption of the respective value for each of the one or more DCI fields.
Clause 5: The method of Clause 4, wherein the indication of the capability of the apparatus comprises a capability flag indication.
Clause 6: The method of any one of Clauses 1-5, further comprising obtaining the DCI based on a successful decode of the downlink control channel candidate, the DCI obtained based on the respective value for each of the one or more DCI fields.
Clause 7: The method of any one of Clauses 1-6, further comprising attempting to decode the downlink control channel candidate without assumption of the respective value for each of the one or more DCI fields.
Clause 8: The method of any one of Clauses 1-7, further comprising: receiving an indication of a monitoring window indicating a number of downlink control channel candidates to decode without assumption of the respective value for each of the one or more DCI fields; and assuming the respective value for each of the one or more DCI fields for subsequent attempts to decode one or more downlink control channel candidates after the number of downlink control channel candidates.
Clause 9: The method of Clause 8, further comprising assuming the respective value for each of the one or more DCI fields based on decoded values for each of the one or more DCI fields comprising unchanged values for the number of downlink control channel candidates.
Clause 10: The method of Clause 8, further comprising: receiving an indication of a configuration of one or more values for one or more respective DCI fields of the one or more DCI fields; and attempting to decode the downlink control channel candidate after the number of downlink control channel candidates based on the one or more values.
Clause 11: The method of any one of Clauses 1-10, wherein the one or more DCI fields are mapped to one or more DCI formats.
Clause 12: The method of Clause 11, further comprising attempting to decode one or more downlink control channel candidates without assumption of the respective value for each of the one or more DCI fields based on the one or more downlink control channel candidates comprising a DCI format not included in the one or more DCI formats.
Clause 13: The method of any one of Clauses 1-12, further comprising receiving the indication of the one or more DCI fields via RRC signaling.
Clause 14: The method of any one of Clauses 1-13, further comprising storing the respective value for each of the one or more DCI fields in a local database, the one or more memories, or a combination thereof.
Clause 15: A method for wireless communications by an apparatus comprising: sending, to a device, an indication of one or more DCI fields that indicates for the device to assume a respective value for each of the one or more DCI fields to attempt to decode a downlink control channel candidate; and sending, to the device, the downlink control channel candidate.
Clause 16: The method of Clause 15, further comprising sending an indication of a configuration of the respective value for each of the one or more DCI fields.
Clause 17: The method of Clause 16, further comprising sending the indication of the configuration via RRC signaling.
Clause 18: The method of any one of Clauses 15-17, further comprising receiving an indication of a capability of the device that indicates a support of the device for assumption of the respective value for each of the one or more DCI fields.
Clause 19: The method of Clause 18, wherein the indication of the capability of the device comprises a capability flag indication.
Clause 20: The method of any one of Clauses 15-19, further comprising: sending a previous downlink control channel candidate prior to the downlink control channel candidate via a first set of time-frequency resources; and sending the downlink control channel candidate via a second set of time-frequency resources based on an assumption of the respective value for each of the one or more DCI fields by the device, the second set of time-frequency resources comprising fewer time-frequency resources than the first set of time-frequency resources.
Clause 21: The method of any one of Clauses 15-20, further comprising sending, to the device, an indication of a monitoring window indicating a number of downlink control channel candidates for the device to decode without assumption of the respective value for each of the one or more DCI fields.
Clause 22: The method of any one of Clauses 15-21, wherein the one or more DCI fields are mapped to one or more DCI formats.
Clause 23: The method of any one of Clauses 15-22, further comprising sending the indication of the one or more DCI fields via RRC signaling.
Clause 24: One or more apparatuses, comprising: one or more memories comprising executable instructions; and one or more processors configured to execute the executable instructions and cause the one or more apparatuses to perform a method in accordance with any one of Clauses 1-23.
Clause 25: One or more apparatuses configured for wireless communications, comprising: one or more memories; and one or more processors, coupled to the one or more memories, configured to cause the one or more apparatuses to perform a method in accordance with any one of Clauses 1-23.
Clause 26: One or more apparatuses configured for wireless communications, comprising: one or more memories; and one or more processors, coupled to the one or more memories, configured to perform a method in accordance with any one of Clauses 1-23.
Clause 27: One or more apparatuses, comprising means for performing a method in accordance with any one of Clauses 1-23.
Clause 28: One or more non-transitory computer-readable media comprising executable instructions that, when executed by one or more processors of one or more apparatuses, cause the one or more apparatuses to perform a method in accordance with any one of Clauses 1-23.
Clause 29: One or more computer program products embodied on one or more computer-readable storage media comprising code for performing a method in accordance with any one of Clauses 1-23.
Clause 30: One or more apparatuses configured for wireless communications, comprising: a processing system that includes one or more processors and one or more memories coupled with the one or more processors, the processing system configured to cause the one or more apparatuses to perform a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more. ” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
a processing system that includes one or more processors and one or more memories coupled with the one or more processors, the processing system configured to cause the apparatus to:
receive an indication of one or more downlink control information (DCI) fields that indicates to assume a respective value for each of the one or more DCI fields to attempt to decode a downlink control channel candidate; and
attempt to decode the downlink control channel candidate to obtain DCI based on the respective value for each of the one or more DCI fields.

2. The apparatus of claim 1, wherein the processing system is configured to cause the apparatus to receive an indication of a configuration of the respective value for each of the one or more DCI fields.

3. The apparatus of claim 2, wherein the processing system is configured to receive the indication of the configuration via radio resource control (RRC) signaling.

4. The apparatus of claim 1, wherein the processing system is configured to cause the apparatus to send an indication of a capability of the apparatus that indicates a support for assumption of the respective value for each of the one or more DCI fields.

5. The apparatus of claim 4, wherein the indication of the capability of the apparatus comprises a capability flag indication.

6. The apparatus of claim 1, wherein the processing system is configured to cause the apparatus to obtain the DCI based on a successful decode of the downlink control channel candidate, the DCI obtained based on the respective value for each of the one or more DCI fields.

7. The apparatus of claim 1, wherein the processing system is configured to cause the apparatus to attempt to decode the downlink control channel candidate without assumption of the respective value for each of the one or more DCI fields.

8. The apparatus of claim 1, wherein the processing system is configured to cause the apparatus to:
receive an indication of a monitoring window indicating a number of downlink control channel candidates to decode without assumption of the respective value for each of the one or more DCI fields; and
assume the respective value for each of the one or more DCI fields for subsequent attempts to decode one or more downlink control channel candidates after the number of downlink control channel candidates.

9. The apparatus of claim 8, wherein the processing system is configured to cause the apparatus to assume the respective value for each of the one or more DCI fields based on decoded values for each of the one or more DCI fields comprising unchanged values for the number of downlink control channel candidates.

10. The apparatus of claim 8, wherein the processing system is configured to cause the apparatus to:
receive an indication of a configuration of one or more values for one or more respective DCI fields of the one or more DCI fields; and
attempt to decode the downlink control channel candidate after the number of downlink control channel candidates based on the one or more values.

11. The apparatus of claim 1, wherein the one or more DCI fields are mapped to one or more DCI formats.

12. The apparatus of claim 11, wherein the processing system is configured to cause the apparatus to attempt to decode one or more downlink control channel candidates without assumption of the respective value for each of the one or more DCI fields based on the one or more downlink control channel candidates comprising a DCI format not included in the one or more DCI formats.

13. The apparatus of claim 1, wherein the processing system is configured to cause the apparatus to receive the indication of the one or more DCI fields via radio resource control (RRC) signaling.

14. The apparatus of claim 1, wherein the processing system is configured to cause the apparatus to store the respective value for each of the one or more DCI fields in a local database, the one or more memories, or a combination thereof.

15. An apparatus configured for wireless communications, comprising:
a processing system that includes one or more processors and one or more memories coupled with the one or more processors, the processing system configured to cause the apparatus to:
send, to a device, an indication of one or more downlink control information (DCI) fields that indicates for the device to assume a respective value for each of the one or more DCI fields to attempt to decode a downlink control channel candidate; and
send, to the device, the downlink control channel candidate.

16. The apparatus of claim 15, wherein the processing system is configured to cause the apparatus to send an indication of a configuration of the respective value for each of the one or more DCI fields.

17. The apparatus of claim 16, wherein the processing system is configured to send the indication of the configuration via radio resource control (RRC) signaling.

18. The apparatus of claim 15, wherein the processing system is configured to cause the apparatus to receive an indication of a capability of the device that indicates a support of the device for assumption of the respective value for each of the one or more DCI fields.

19. The apparatus of claim 18, wherein the indication of the capability of the device comprises a capability flag indication.

20. The apparatus of claim 15, wherein the processing system is configured to cause the apparatus to:
send a previous downlink control channel candidate prior to the downlink control channel candidate via a first set of time-frequency resources; and
send the downlink control channel candidate via a second set of time-frequency resources based on an assumption of the respective value for each of the one or more DCI fields by the device, the second set of time-frequency resources comprising fewer time-frequency resources than the first set of time-frequency resources.

21. The apparatus of claim 15, wherein the processing system is configured to cause the apparatus to send, to the device, an indication of a monitoring window indicating a number of downlink control channel candidates for the device to decode without assumption of the respective value for each of the one or more DCI fields.

22. The apparatus of claim 15, wherein the one or more DCI fields are mapped to one or more DCI formats.

23. The apparatus of claim 15, wherein the processing system is configured to cause the apparatus to send the indication of the one or more DCI fields via radio resource control (RRC) signaling.

24. A method for wireless communications by an apparatus comprising:
receiving an indication of one or more downlink control information (DCI) fields that indicates to assume a respective value for each of the one or more DCI fields to attempt to decode a downlink control channel candidate; and
attempting to decode the downlink control channel candidate to obtain DCI based on the respective value for each of the one or more DCI fields.

25. The method of claim 24, further comprising receiving an indication of a configuration of the respective value for each of the one or more DCI fields.

26. The method of claim 24, further comprising sending an indication of a capability of the apparatus that indicates a support for assumption of the respective value for each of the one or more DCI fields.

27. The method of claim 24, further comprising obtaining the DCI based on a successful decode of the downlink control channel candidate, the DCI obtained based on the respective value for each of the one or more DCI fields.

28. The method of claim 24, further comprising attempting to decode the downlink control channel candidate without assumption of the respective value for each of the one or more DCI fields.

29. The method of claim 24, further comprising:
receiving an indication of a monitoring window indicating a number of downlink control channel candidates to decode without assumption of the respective value for each of the one or more DCI fields; and
assuming the respective value for each of the one or more DCI fields for subsequent attempts to decode one or more downlink control channel candidates after the number of downlink control channel candidates.

30. A method for wireless communications by an apparatus comprising:
sending, to a device, an indication of one or more downlink control information (DCI) fields that indicates for the device to assume a respective value for each of the one or more DCI fields to attempt to decode a downlink control channel candidate; and
sending, to the device, the downlink control channel candidate.
